(19) United States
(12) Patent Application Publication
(10) Pub. No.: US 2024/0253156 A1
(43) Pub. Date: Aug. 1, 2024

(54) METHOD FOR THE LASER WELDING OF A WORKPIECE WITH A RAPID CHANGE BETWEEN WELDING ZONES HAVING DIFFERENT MATERIALS TO BE WELDED

(71) Applicant: TRUMPF Laser- und Systemtechnik GmbH, Ditzingen (DE)

(72) Inventor: Oliver Bocksrocker, Sachsenheim (DE)

(21) Appl. No.: 18/635,042

(22) Filed: Apr. 15, 2024

Related U.S. Application Data
(63) Continuation of application No. PCT/EP2022/077365, filed on Sep. 30, 2022.

(30) Foreign Application Priority Data
Oct. 15, 2021 (DE) 10 2021 126 754.4

(51) Int. Cl. B23K 26/067; B23K 26/064; B23K 26/082; B23K 26/21

(52) U.S. Cl. CPC B23K 26/067; B23K 26/064; B23K 26/082; B23K 26/21

(57) ABSTRACT

A method for laser welding of a workpiece includes directing a laser beam onto the workpiece by using scanner optics, and in an arbitrary order with the laser beam, welding a first component to a base part of the workpiece at least in a first welding zone, and welding a second component to the base part in a second welding zone. A laser energy of the laser beam is capable of being split variably at least between a core fraction corresponding to a core beam of the laser beam, and a ring fraction corresponding to a ring beam of the laser beam that encloses the core beam. The splitting of the laser energy between the core fraction and the ring fraction is selected differently for welding in the first welding zone and for welding in the second welding zone.

### CROSS REFERENCE TO RELATED APPLICATIONS

This application is a continuation of International Application No. PCT/EP2022/077365 (WO 2023/061783 A1), filed on Sep. 30, 2022, and claims benefit to German Patent Application No. DE 10 2021 126 754.4, filed on Oct. 15, 2021. The aforementioned applications are hereby incorporated by reference herein.

### FIELD

Embodiments of the present invention relate to a method for laser welding of a workpiece.

### BACKGROUND

Laser welding is an efficient method for the joining of workpiece parts to form a workpiece. Laser welding is used especially when a high welding speed, a narrow weld seam or else low thermal distortion in the workpiece are desired.

In many cases, a plurality of components are intended to be welded to a base part during the laser welding. In cells for electric batteries, for example, the cathode often comprises aluminum (Al) or an aluminum alloy, and the anode often comprises copper (Cu) or a copper alloy, and these two components are intended to be welded to a common base part of the cell.

Conventionally, the workpiece to be welded (or its workpiece parts that are intended to be welded to one another) is arranged in front of scanner optics for the laser welding. The scanner optics generally comprise an input for laser radiation, to which a fiber-optic cable is typically attached, various optical elements (usually a collimation lens or collimation lens system and a focusing lens or focusing lens system) and an adjustable deflecting instrument (usually a mirror that can be adjusted with piezo elements), with which the alignment of the laser beam emerging from the scanner optics can be varied relative to the workpiece, in order to guide the laser beam along a desired welding path (weld seam) or else to align the laser beam successively onto different welding zones at which the various components are welded to the base part.

For the laser welding of components of different materials, in many cases different spot sizes of the welding laser beam are advantageous, in order to minimize splatter and pores. For this purpose, the distance of the scanner optics, or of the laser processing head, from the workpiece in the beam propagation direction may be varied. For example, if the workpiece surface facing toward the laser beam is located in the focal plane of the laser beam in a first relative setting of the scanner optics with respect to the workpiece, the spot size of the laser beam on the workpiece surface is smallest. By relative withdrawal of the workpiece surface from the focal plane into a second relative setting, the spot size of the laser beam on the workpiece surface may be increased.

The displacement of the scanner optics relative to the workpiece is, however, complicated and takes a relatively long time. Thus, if components of different materials are intended to be welded successively to a common base part on a workpiece, the manufacture of the workpiece becomes comparatively slow with the procedures described above; during the manufacture of such workpieces in series, the delay due to adjusting the scanner optics occurs with each workpiece.

It is known from DE 10 2010 003 750 A1 to vary the beam profile characteristic of a laser beam by means of a multiclad fiber comprising at least a core fiber and a ring fiber. A starting laser beam is fed with one fraction (core fraction) into a core fiber and with another fraction (ring fraction) into a ring fiber; the fractions may, for example, be varied by the position of an optical wedge in the starting laser beam in front of the fiber end of the multiclad fiber. With the multiclad fiber, a reshaped laser beam having a core beam and a ring beam with adjustable fractions may accordingly be provided.

### SUMMARY

Embodiments of the present invention provide a method for laser welding of a workpiece. The method includes directing a laser beam onto the workpiece by using scanner optics, and in an arbitrary order with the laser beam, welding a first component to a base part of the workpiece at least in a first welding zone, and welding a second component to the base part in a second welding zone. The first component and the second component comprise different materials at least in the first welding zone and the second welding zone. A laser energy of the laser beam is capable of being split variably at least between a core fraction corresponding to a core beam of the laser beam, and a ring fraction corresponding to a ring beam of the laser beam that encloses the core beam. The splitting of the laser energy between the core fraction and the ring fraction is selected differently for welding in the first welding zone and for welding in the second welding zone.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows in a schematic longitudinal section along a fiber-optic cable the region of an exemplary variable splitting device for splitting the laser energy of a laser beam, according to some embodiments;

FIG. 1b shows a fiber end of the fiber-optic cable from FIG. 1a in a plan view according to some embodiments;

FIG. 2 shows in a schematic longitudinal section exemplary scanner optics, according to some embodiments;

FIG. 3a illustrates in a schematic side view the processing of an exemplary workpiece according to some embodiments;

FIG. 3b shows a schematic plan view of the workpiece of FIG. 3b according to some embodiments;

FIG. 4a shows a diagram of a laser intensity of a laser beam as a function of the location transversely to the beam propagation direction in the focal plane during the laser welding of a first component in a first welding zone of a workpiece in an exemplary variant of the method according to some embodiments;

FIG. 4b shows a schematic diagram of the laser intensity of the laser beam as a function of the location transversely to the beam propagation direction in the focal plane during the laser welding of a second component in a second welding zone of the workpiece in the variant of FIG. 4a according to some embodiments;

FIG. 5 shows a schematic diagram of the time profile of the core fraction during the welding of the first and second welding zones according to some embodiments; and

FIG. 6 shows a schematic perspective view of a lid of a prismatic cell of an electric battery, which has been welded with the method according to some embodiments.

### DETAILED DESCRIPTION

Embodiments of the present invention provide a method for laser welding of a workpiece, with which the manufacture of workpieces, wherein components made of different materials are welded onto a base part, can be accelerated.

According to some embodiments, a laser beam is directed onto the workpiece by means of scanner optics. In an arbitrary order with the laser beam, a first component is welded to a base part at least in a first welding zone and a second component is welded to the base part in a second welding zone. The first component and the second component comprise different materials at least in the region of the first and second welding zones.

A laser energy of the laser beam can be split variably at least between a core fraction, corresponding to a core beam of the laser beam, and a ring fraction, corresponding to a ring beam which encloses the core beam.

The splitting of the laser energy between the core fraction and the ring fraction is selected differently when welding the first welding zone and when welding the second welding zone.

According to some embodiments of the invention, it is provided to select differently the splitting of the laser energy between a core fraction and a ring fraction for the laser welding of at least two components of different material onto a common base part. By varying the splitting of the laser power between a core fraction and a ring fraction, it is possible to vary or adjust the effective spot size of the welding laser beam on the surface of the workpiece that respectively faces toward the laser beam. The spot size may thereby be adjusted to the situations in the various welding zones, or to the various components, and in particular to their different materials. At the same time, the intensity profile of the (overall) laser beam is also varied, or adjusted, during the processing. Both may be used to optimize the quality of the laser welding on the various welding zones, or on the various components, and in particular to minimize splatter and pores.

For these variations or adjustments, it is not necessary to vary the position of the scanner optics, which would be complicated and time-consuming. According to some embodiments of the invention, the position of the scanner optics relative to the workpiece is therefore preferably kept constant during the welding of the first and second welding zones, and also during a change between the welding zones. Alternatively, a combination of a (relative) displacement of the workpiece and the scanner optics and switching the splitting of the laser energy between the core fraction and the ring fraction may be used in order to vary the (effective) spot size when changing the welding zones; in this case, a significant shortening of the (relative) displacement path can be achieved, which leads to a corresponding shortening of the downtime for the welding zone change and can therefore significantly also still accelerate the welding method overall. The variation of the splitting of the laser power is possible rapidly and with little effort, for example by slight displacement of an optical wedge, and in particular does not cause a significant downtime.

The effective spot size of a laser beam or beam fraction (for example an overall laser beam comprising a core fraction and a ring fraction, or a core beam alone, or a ring beam alone) may be determined according to the 86% criterion. According to the 86% criterion, the spot size of a laser beam is defined by the diameter of a circular surface (coaxial with the laser beam) inside which 86% of the laser power of the laser beam is contained.

By varying the effective spot size through the change of the splitting of the laser energy between the core fraction and the ring fraction, it is possible to adjust the seam width (width of the weld seam transversely to the direction of advance), which is important in many applications, straightforwardly and rapidly, in particular suitably for the various materials in the different components. For example, a comparatively wide seam may be selected for Al-based cathodes and a comparatively narrow seam may be selected for Cu-based anodes, in order to accommodate the different melting properties (viscosities and wetting properties) of the materials involved. The method according to embodiments of the invention, or the adaptation of the spot size, may in particular be used in order to achieve an equal welding depth in the various welding zones, or in the various components. Welding defects, in particular splatter and pores, may likewise be minimized.

In order to increase the seam width/spot size, the ring fraction is increased in relation to the core fraction. In order to reduce the seam width/spot size, the ring fraction is decreased in relation to the core fraction. In this way, the effective spot size may be adjusted substantially in a range between the spot size of the ring fraction (alone) and the spot size of the core fraction (alone). It should be noted that the variation of the splitting of the laser energy between the core fraction and the ring fraction alters neither the spot size of the core fraction nor the spot size of the ring fraction. In some embodiments, the spot size of the core beam and the spot size of the ring beam correspondingly remain constant when there is a change between the first welding zone and the second welding zone.

The workpiece to be manufactured is welded together from the base part and the (at least) two components. Typically, the laser power of the laser beam remains constant overall as a function of time (both over the various welding zones and inside the welding zones) during the welding of the workpiece. The first and second welding zones are spaced apart from one another at least transversely to the beam propagation direction. Typically, the two welding zones on the workpiece lie at an equal distance (in the beam propagation direction) from the scanner optics and any angle offset with respect to the optical axis of the scanner optics is in each case negligibly small (for example less than 5°) or at least approximately equal for each of the two welding zones (for example with a difference of less than 5°).

The ring beam usually has a constant intensity in the circumferential direction (usually generated by splitting a starting laser beam between a core fiber and a ring fiber and multiple reflection of the laser light in the ring fiber); it is, however, also possible to use a ring beam having a plurality of local maxima following one another in the circumferential direction (for example generated by a DOE, diffractive optical element, or ROE, refractive optical element). The scanner optics are usually selected as 2D scanner optics with a fixed focal position in the beam propagation direction in front of the scanner optics. Typically, the laser beam is provided via a fiber-optic cable with a core fiber and a ring fiber, a core fiber diameter KFD usually being selected in the range 10 μm-50 μm (for single mode) or 50 μm-400 μm, in particular 50 μm-200 μm (for multimode), and an (outer) ring fiber diameter ARFD usually being selected in the range 20 μm-500 μm, in particular 40-200 μm (for single mode), or with 40 μm-2000 μm, in particular 80 μm-800 μm (for multimode). Usually, the ratio KFD:ARFD is 1:2 to 1:10, preferably 1:4. A (front) fiber end of the fiber-optic cable is attached to the scanner optics (processing head). A (rear) fiber end of the fiber-optic cable is attached to a laser source (laser module), and in some variants attached to a plurality of laser sources (laser modules). A laser source may be configured for cw operation or pulsed operation. According to some embodiments of the invention, single-mode operation or multimode operation may be selected.

According to some embodiments of the invention, a fiber laser is preferably used as the laser source; alternatively, a disk laser may for example also be used as the laser source.

In some embodiments, a position of the scanner optics relative to the workpiece remains the same when welding the first welding zone and when welding the second welding zone. The workpiece and the scanner optics are thus not displaced in relation to one another, not even when changing the welding zone on the workpiece. A very great acceleration in the processing of the workpiece, and in particular also of a multiplicity of successively processed workpieces of a series, may thereby be achieved since a relative displacement of the scanner optics with respect to the workpiece does not take place and therefore does not cause any downtime either. The adaptation of a spot size may take place solely and rapidly by switching the splitting of the laser energy between the core fraction and the ring fraction. In addition, a simple structure of the welding apparatus may be used, if desired, since a corresponding rapid and automated possibility of displacement between the workpiece and the scanner optics is in principle not required.

According to some embodiments, the core fractions of the laser energy differ by at least 20%, preferably at least 30%, as a time average during the welding of the first welding zone and the welding of the second welding zone. A significant variation of the effective spot size (or effective overall diameter) of the laser beam may thereby be achieved. By switching the distribution of the laser energy between the welding zones, the seam width, corresponding to the “effective overall diameter” of the laser beam (for instance determined according to the 86% criterion, measured on the workpiece surface facing toward the laser), is also switched. Typically, the effective overall diameter of the laser beam likewise varies from the first welding zone to the second welding zone by at least 20%, preferably at least 30%, based on the larger diameter.

Furthermore preferred is a variant which provides that the following applies for the core fraction KA1 as a time average and/or in a main phase during the welding of the first welding zone:
0%≤KA1≤60%, preferably 20%≤KA1≤50%,

and that the following applies for the core fraction KA2 as a time average and/or in a main phase during the welding of the second welding zone:
40%≤KA2≤100%, preferably 50%≤KA2≤70%. In this variant, in principle KA1<KA2 furthermore also applies, preferably KA1≤KA2−20%, preferably KA1≤KA2−30%. Such splitting of the laser energy has proven suitable in practice, in particular for welding an Al-based first component on the first welding zone and a Cu-based second component on the second welding zone.

In some embodiments, the first component comprises Al or an Al alloy at least in the region of the first welding zone, and the second component comprises Cu or a Cu alloy at least in the region of the second welding zone. The first component (Al/Al alloy, typically having at least 50 wt % Al) may be provided for a cathode and the second component (Cu/Cu alloy, typically having at least 50 wt % Cu) may be provided for an anode of a battery or battery cell. The base part may, for example, be made from aluminum or steel. Terminals (local coatings), in particular of Al, Al alloys, Cu or Cu alloys, may be provided on the base part in the region of the components to be welded, a terminal comprising the same material preferably being selected for a respective component (less commonly, a component comprising Al/Al alloy may be welded onto a terminal comprising Cu/Cu alloy). The Al alloy may be selected as a 1000 series alloy. The Cu alloy may be selected as CU-EPT or CU-OF. This procedure has proven suitable in practice for the manufacture of Al-based and Cu-based components. For both types of components, weld seams that are low in splatter and pores could be manufactured by means of switching the energy distribution, without displacing the scanner optics relative to the workpiece.

In some embodiments, the workpiece is part of an electric battery, in particular a lid for a prismatic cell of the electric battery, and that the first component forms a cathode and the second component forms an anode for the electric battery, in particular wherein the first component and the second component are each configured as a fork-like soft connector for the prismatic cell. With the method according to embodiments of the invention, the high quality of the weld seams, or high reliability of the manufactured battery parts, which is required for electric batteries, can be ensured efficiently.

Also preferred is a variant in which, when welding the first welding zone and/or when welding the second welding zone, the core fraction of the laser energy is increased during an initial phase and/or the core fraction of the laser energy is reduced during an end phase. By such power ramps, in particular, splatter at the start and pores at the end of the respective process (welding a respective welding zone) may be reduced. Typically, the splitting of the laser energy remains constant during a main phase (between the initial phase and the end phase) when welding a respective welding zone. The power ramps in the initial phase and in the end phase of the welding of a respective welding zone are typically applied over a period of 5-500 ms, preferably 10-50 ms. In an initial phase, the core fraction may for example start at a value which is reduced by (at least) 20%, or even by (at least) 40%, in relation to the setpoint value (in the main phase). In an end phase, the core fraction may for example end at a value which is reduced by (at least) 20%, or even by (at least) 40%, in relation to the setpoint value (in the main phase). The power ramps are typically implemented linearly as a function of time.

Preferred is a variant in which, in order to generate the laser beam, a starting laser beam is split into the core beam and the ring beam with a variable splitting device. This is simple to implement; in particular, a laser module (a laser source) for the starting laser beam is merely required.

A preferred development of this variant provides that, with the variable splitting device, the starting laser beam is fed according to the desired splitting of the laser energy with corresponding fractions into a core fiber and into a ring fiber, which encloses the core fiber, in particular wherein the variable splitting device comprises a displaceable optical wedge. The core beam and the ring beam may be generated straightforwardly by means of the core fiber and the ring fiber, in particular with a relatively uniform intensity distribution over the respective beam cross section, both radially and azimuthally. The displaceable optical wedge is simple to implement.

In another development, it is provided that, with the variable splitting device, the starting laser beam is guided according to the desired splitting of the laser energy with corresponding fractions past a DOE or ROE and through the DOE or ROE, in particular wherein the DOE or ROE is displaceable. With a DOE (diffractive optical element) or ROE (refractive optical element), the beam fraction incident thereon is deflected (optionally into a plurality of local maxima), and this deflected beam fraction provides the ring beam. The undeflected beam fraction, which travels past the DOE or ROE, constitutes the core fraction. This structure is simple and compact to implement; a multiclad fiber is not required.

An alternative advantageous variant provides that, in order to generate the laser beam, the core beam is generated with a first laser module and the ring beam is generated with a second laser module, the power of the first laser module and the power of the second laser module being variably adjustable,

in particular wherein the first laser module feeds a first precursor laser beam into a core fiber and the second laser module feeds a second precursor laser beam into a ring fiber, which encloses the core fiber. In this variant, the laser power in the core beam and the laser power in the ring beam may straightforwardly be adjusted independently of one another. By means of the core fiber and the ring fiber, the core beam and the ring beam may be provided with a comparatively uniform intensity distribution, both azimuthally and radially.

In one preferred variant, it is provided that the following applies for the diameters KSD′ of the core beam and ARSD′ of the ring beam, measured on a workpiece surface facing toward the laser beam:
1/10≤ KSD′/ARSD′≤1/2,
preferably 1/3≤ KSD′/ARSD′≤1/5,
Preferably KSD′/ARSD′=1/4. These ranges for the core beam diameter KSD′ and the (outer) ring beam diameter ARSD′ have proven suitable in practice, and are usually quite sufficient for adapting to the situations of different components (for instance Al-based and Cu-based).

In some embodiments, the diameters KSD′ of the core beam and ARSD′ of the ring beam, measured on a workpiece surface facing toward the laser beam, remain constant during the welding of the first welding zone and of the second welding zone. This is simple to implement, especially with 2D scanner optics (and welding zones spaced equally far apart from the scanner optics in the beam propagation direction).

In an alternative variant, it is provided that the scanner optics are configured as 3D scanner optics, and that the diameters KSD′ of the core beam and ARSD′ of the ring beam, measured on a workpiece surface facing toward the laser beam, are varied by means of the 3D scanner optics during the welding of the first welding zone and of the second welding zone by changing the focal position in the propagation direction of the laser beam. The range within which the effective spot size of the overall processing laser beam can be adjusted may thereby be increased (in the case of welding zones spaced equally far apart from the scanner optics in the beam propagation direction). Typically, the focal position is altered only when changing the welding zone.

In some embodiments, for the laser beam when welding the first welding zone and/or the second welding zone, in a focal plane,
the core beam has a core beam diameter KSD inside which there is 86% of the laser power of the core beam,
the ring beam has an outer ring beam diameter ARSD inside which there is 86% of the laser power of the ring beam, and
the ring beam has an inner ring beam diameter IRSD on which there is an equal radiation density of the ring beam, averaged over the circumference, as on the outer ring beam diameter ARSD, so that there is an intensity gap between the inner ring beam diameter IRSD and the core beam diameter KSD with an intensity gap width ILB=(IRSD−KSD)/2,
and that ILB≤0.3*KSD and ILB<10 μm*AV, with AV being the imaging ratio of the scanner optics,
in particular wherein the laser beam is provided at a fiber end of a fiber-optic cable, and the fiber-optic cable is formed at least with a core fiber having a core fiber diameter KFD, a ring fiber annularly enclosing the core fiber and having an outer ring fiber diameter ARFD, and a cladding layer lying between the core fiber and the ring fiber, enclosing the core fiber and having a cladding layer thickness MSD, with MSD≤0.3*KFD and MSD<10 μm. This procedure leads to stable vapor capillaries and correspondingly to few welding defects such as splatter, pores or cracks. In particular MSD≤0.2*KFD and/or furthermore ILB≤0.2*KSD, preferably MSD≤0.15*KFD and/or furthermore ILB≤0.15*KSD, preferably MSD≤0.1*KFD and/or furthermore ILB≤0.1*KSD, may also apply. Furthermore, MSD≤9 μm and/or ILB≤9 μm*AV, preferably MSD≤7 μm and/or ILB≤ 7 μm*AV, preferably MSD≤6 μm and/or ILB≤6 μm*AV, may apply in particular.

Furthermore preferred is a method variant in which the welding of the first welding zone and the welding of the second welding zone take place in such a way that
for a welding depth ET, 100 μm≤ET≤5 mm applies, and/or
for an aspect ratio T:B of a depth T to a width B of a generated weld seam: T:B≥0.5:1 applies, and/or
for a beam parameter product SPP of the laser beam in single mode, 0.38 mm*mrad≤SSP≤16 mm*mrad applies, preferably with SSP≤0.6 mm*mrad, or in multimode, SSP≤ 100 mm*mrad applies, preferably with SSP≤32 mm*mrad, and/or
for an overall beam diameter GD′ of the laser beam on the workpiece surface facing toward the laser beam in the single mode, 10 μm≤ GD′≤300 μm applies, preferably with 30 μm≤ GD′≤70 μm, or in the multimode 50 μm≤ GD′≤1200 μm applies, and/or
the laser beam is generated with at least one IR laser with an average wavelength MWL, with 800 nm≤ MWL≤1200 nm, preferably 1030 nm≤ MWL≤1070 nm, or at least one VIS laser, in particular with an average wavelength MWL, with 400 nm≤ MWL≤ 450 nm or 500 nm≤ MWL≤530 nm, and/or
the scanner optics have an imaging ratio AV, with 1:1≤AV≤5:1, preferably 1.5:1≤AV≤2:1. These parameters have proven suitable in practice. The (effective) overall diameter GD′ (“spot size”) may be determined by means of the 86% criterion for the (overall) laser beam.

Embodiments of the present invention also include a prismatic cell for an electric battery, comprising a lid and two fork-like soft connectors, wherein the soft connectors as the first and second component are welded to the lid as the base part with a method as described above. The lid of the prismatic cell may be manufactured simply, rapidly and with high quality according to embodiments of the invention. The first and second components are typically formed by an Al-based cathode and a Cu-based anode.

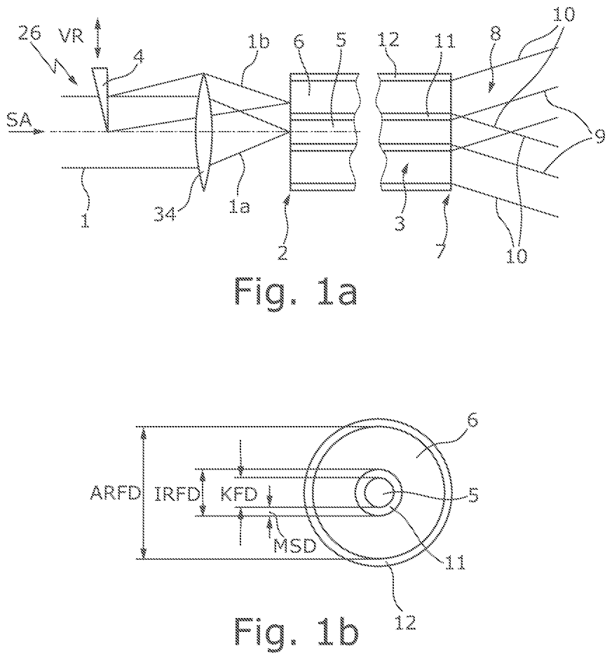

FIGS. 1a to 3b illustrate various parts of an exemplary structure for the laser welding of workpieces, with which the method according to embodiments of the invention may be carried out.

As may be seen in FIG. 1a, a starting laser beam 1 is fed by means of a focusing lens 34 into a rear fiber end 2 of a multiclad fiber 3 (which is configured in this case as a double-clad fiber). An optical wedge 4 protrudes into the beam path of the starting laser beam 1, in the situation shown radially from the outside approximately as far as the middle of the starting laser beam 1.

A first part 1a of the starting laser beam 1, which is guided past the optical wedge 4 (in FIG. 1a the lower part of the starting laser beam 1), is fed by the focusing lens 34 at the rear fiber end 2 into a core fiber 5 of the multiclad fiber 3. A second part 1b of the starting laser beam 1, which is deflected by the optical wedge 4 (in FIG. 1a the upper part of the starting laser beam 1), is fed by the focusing lens 4 at the rear fiber end 2 into a ring fiber 6 of the multiclad fiber 3.

At a front fiber end 7, the multiclad fiber 3 then provides an unshaped laser beam 8. The laser beam 8 comprises a core beam 9, which emerges from the core fiber 5, and a ring beam 10, which emerges from the ring fiber 6. The core beam 9 and the ring beam 10 in principle emerge divergently from the fiber end 7. The overall laser energy of the laser beam 8 (which substantially corresponds to the laser energy of the starting laser beam 1) is split according to the splitting induced by the optical wedge 4 between the core beam 9 (core fraction, originating from the first part 1a) and the ring beam 10 (ring fraction, originating from the second part 1b).

In order to vary the splitting of the laser energy between the core fraction and the ring fraction, the optical wedge 4 may be displaced transversely to a beam propagation direction SA of the starting laser beam 1 along a displacement direction VR. If for example the optical wedge 4 is drawn upward starting from the situation of FIG. 1a (back out from the starting laser beam 1), the core fraction is increased and the ring fraction is decreased; if conversely the optical wedge 4 is moved downward (further into the starting laser beam 1), the core fraction is decreased and the ring fraction is increased. The optical wedge 4 in the starting laser beam 1 in front of the rear fiber end 2 of the multiclad fiber 3 accordingly forms a variable splitting device 26.

It should be noted that, in other configurations, a core beam and a ring beam may be generated in other ways and a laser energy may be split between the core beam and the ring beam in other ways, for example by means of a plurality of independent laser modules or else by means of a DOE or ROE (not represented in detail) that can be displaced variably far into the starting laser beam.

FIG. 1b shows in a plan view the front fiber end 7 of the multiclad fiber 3 of FIG. 1a. The core fiber 5 is circular in cross section and has a core fiber diameter KFD, which in the example shown is 75 μm. The ring fiber 6, which annularly encloses the core fiber 5, is likewise circular in cross section and has an outer ring fiber diameter ARFD and an inner ring fiber diameter IRFD, which in the example shown are configured with ARFD=300 μm and IRFD=90 mm. A cladding layer (cladding) 11 arranged between the core fiber 5 and the ring fiber 6 has a cladding layer thickness MSD of in this case 7.5 μm. A further cladding layer (cladding) 12 is arranged around the ring fiber 6 on the outside. For the ratio of MSD and KFD, MSD=0.15*KFD thus approximately applies in this case. In a further example, for example, KFD may also be selected at 75 μm and ARFD at 400 μm.

It should be noted that the geometry of the cross section of the core fiber 5 and of the ring fiber 6 substantially corresponds to the beam cross section of the laser beam 8 with the core beam 9 and the ring beam 10 at the front fiber end 7 or else (after imaging by the scanner optics) in a focal plane of the laser beam 8, in the latter case stretched or compressed according to the imaging ratio AV of the imaging. In particular, the core beam 9 and the ring beam 10 are thus also circular in cross section in a manner corresponding to the fiber geometry (see also FIG. 1a in this regard).

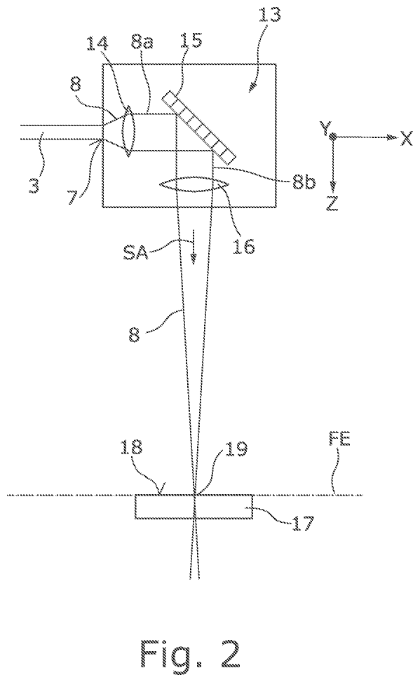

As represented in FIG. 2, the multiclad fiber 3 is attached to scanner optics 13. In the configuration shown, the laser beam 8 emerging at the front fiber end 7 (which already comprises the core beam and the ring beam) is collimated by a collimating lens 14. The collimated (parallelized) laser beam 8a strikes a scanner mirror 15, which can be tilted about two axes, in the coordinate system of FIG. 2 about the x axis and about the y axis (which extends perpendicularly to the plane of the drawing; x, y, z form a Cartesian coordinate system). A reflected collimated laser beam 8b is then focused by a focusing lens 16 into a focal plane FE in the direction of a workpiece 17 to be welded. In the example illustrated, a surface 18 of the workpiece 17 facing toward the laser beam 8 lies in the focal plane FE.

By tilting the scanner mirror 15, the laser beam 8, or its laser spot 19, can be moved on the surface 18 of the workpiece 17, in order to execute (that is to say manufacture) desired weld seams on the workpiece 17 or else to change between different welding zones on the workpiece, in each of which a weld seam is intended to be manufactured.

In the example shown, the surface 18 of the workpiece 17 (at least where laser processing is intended to take place on the workpiece 17) is approximately perpendicular to the central beam propagation direction SA of the laser beam 8; the central beam propagation direction SA corresponds in this case substantially to the optical axis of the focusing lens 16, and in this case lies in the z direction.

During the processing of the workpiece 17 with the laser beam 8, including during the change between welding zones, the relative position of the scanner optics 13 and the workpiece 17 remains fixed in the variant presented here, in respect of the distance between them in the z direction of FIG. 2 (which extends along the beam propagation direction SA). The scanner optics 13 are not displaced (although the scanner mirror 15 within the scanner optics 13 is tilted). In an alternative variant, a relative displacement may also be provided between the workpiece 17 and the scanner optics 13 when processing the workpiece 17, wherein the relative displacement path may be shortened in order to adjust an effective spot size during the welding zone change by the splitting of the laser energy being switched according to embodiments of the invention (not represented in detail).

In the configuration shown, the distance (in the z direction) of the focal plane FE from the scanner optics 13 is also fixed; the scanner optics 13 are thus configured as 2D scanner optics). In an alternative configuration, the placement of the focal plane FE may also be variable with respect to the scanner optics 13, for example by displacing the focusing lens 16 in the z direction within the scanner optics 13 (not represented in detail).

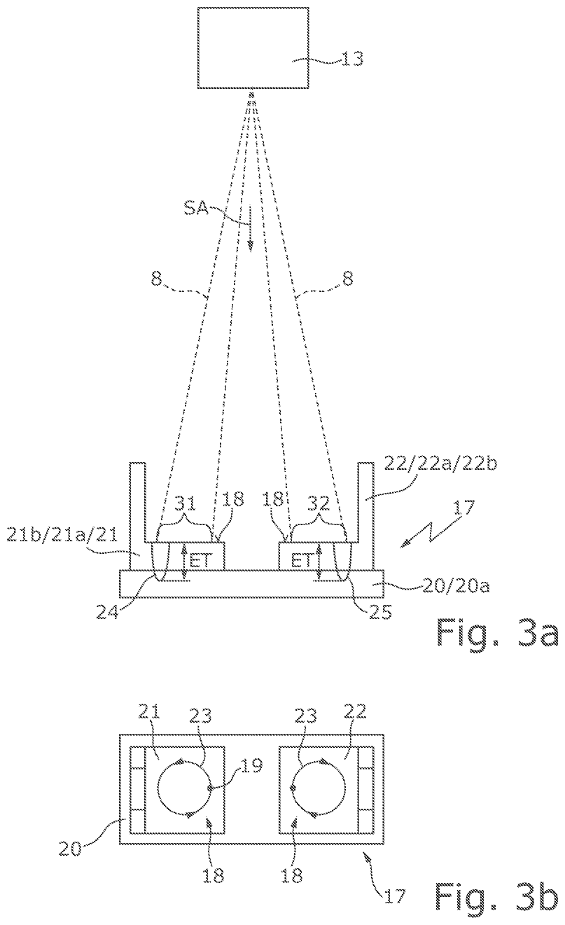

FIG. 3a explains the processing of the workpiece 17 according to embodiments of the invention in more detail. The workpiece 17 in this case comprises a base part 20, on which a first component 21 and a second component 22 are intended to be welded. In the example illustrated, the base part 20 is a lid 20a for a prismatic cell of an electric battery, the lid 20a being made in this case from an Al alloy. The first component 21 is in this case a cathode 21a for the cell, the first component 21 being configured as a fork-like soft connector 21b (cf. also FIG. 6 in this regard); the first component 21 is in this case likewise made from an Al alloy. The second component 22 is in this case an anode 22a for the cell, the second component 22 again being configured as a fork-like soft connector 22b (cf. also FIG. 6 in this regard); the second component 22 is in this case made from a Cu alloy.

During the processing of the workpiece 17, the processing laser beam 8 emerging from the scanner optics 13 is directed (in an arbitrary order) successively onto a first welding zone 31 and a second welding zone 32, in order to weld the first component 21 in the first welding zone 31 and the second component 22 in the second welding zone 32 to the base part 20. In the variant shown, the two components 21, 22 lie in front of the base part 20 here (in relation to the central beam propagation direction SA); this is also generally preferred.

As may be seen in FIG. 3b, in the variant shown annularly closed weld seams are manufactured here, corresponding to a respective path 23 of the laser spot 19 of the laser beam 8 on the surface 18 of the workpiece 17, this surface 18 lying on the components 21, 22 in this case. Alternatively, for example, hatching could also respectively be welded (not represented in detail).

Since the two components 21, 22 comprise different materials, the welding effect of a laser beam on the two components 21, 22 is in principle different. This may, for example, result in different formation of welding defects (splatter, pores, cracks, etc.). The different materials may in particular have effects on a respective welding depth ET; the welding depth ET is the depth at which the material of the workpiece 17 is melted by the laser beam 8, cf. in this regard the melting fronts 24, 25 indicated by way of example in FIG. 3a. In principle, it is desirable to optimize the welding effect for each component 21, 22, or each material involved, and for example to minimize welding defects or, for many applications, even to achieve an approximately equal welding depth ET for all components 21, 22.

According to embodiments of the invention, for this purpose the energy distribution in the laser beam 8 between the core fraction (core beam) and the ring fraction (ring beam) is switched when changing the welding zone 31, 32 on the workpiece 17; conversely, in the variant illustrated, the position of the workpiece 17 in relation to the scanner optics 13 remains the same.

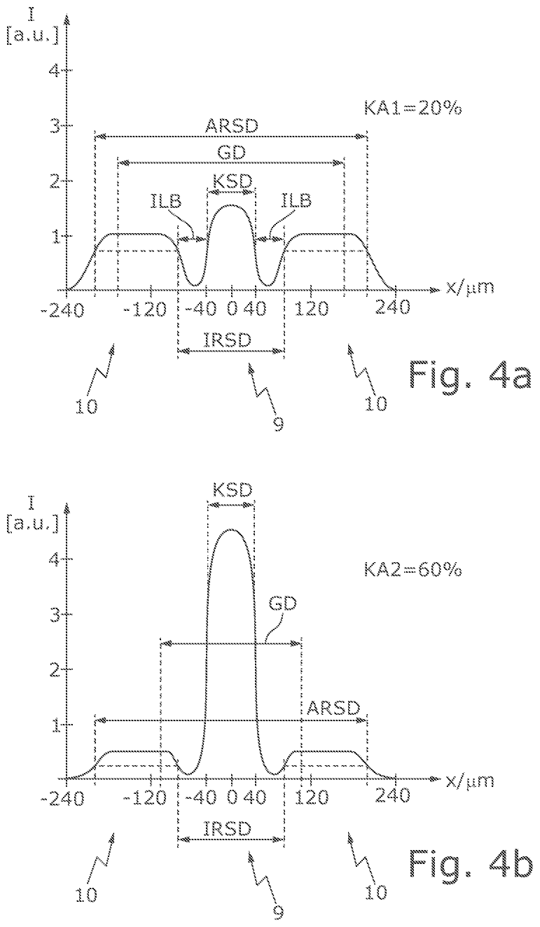

Possible different splits of laser energy between the two welding zones 31, 32, or components 21, 22, as may be performed according to embodiments of the invention, are explained by way of example with the aid of FIGS. 4a and 4b. Both figures each show a diagram of the local laser intensity as a function of the location along an axis x which is perpendicular to the beam propagation direction and passes through a midaxis of the laser beam (“intensity profile”). It should be noted that the laser beam is substantially rotationally symmetrical with respect to this midaxis.

The intensity profiles are each defined in the focal plane. It should be noted that the focal plane preferably coincides with the workpiece surface facing toward the laser beam; in this case, the intensity profile of the focal plane shown simultaneously corresponds to the intensity profile on the workpiece surface (and the values of the focal plane shown without a prime suffix simultaneously corresponding to the values of the workpiece surface with a prime suffix, for example KSD=KSD′, etc.).

The intensity is in each case indicated in arbitrary units a.u. The intensity profiles may be generated with a structure similar to that explained in FIGS. 1a to 3b.

FIG. 4a shows an intensity profile as is used in the first welding zone when welding the first component. For this, a first core fraction KA1 of 20% and a first ring fraction RA1 of 80% were selected as the energy split. A core beam 9 and a ring beam 10 are thus superimposed in the intensity profile.

The core beam 9 leads to a central local intensity maximum with a maximum intensity of about 1.5 a.u. A core beam diameter KSD of the core beam, determined according to the 86% criterion (so that 86% of the laser power of the core beam 9 is contained within the diameter KSD), is in this case approximately 75 μm. The ring beam 10 has a plateau region on each side of the core beam maximum, with a maximum intensity of about 1.0 a.u. An outer ring beam diameter ARSD of the ring beam 10, determined according to the 86% criterion (so that 86% of the laser power of the ring beam 10 is contained within the diameter ARSD), is in this case approximately 400 μm. At the location of ARSD, on the outer side of the ring beam, the intensity of the ring beam 10 has already fallen somewhat in relation to the maximum intensity of the plateau region. If the corresponding (equal) intensity is sought on the inner side of the ring beam 10, this entails an inner ring beam diameter IRSD that in this case is about 160 μm. In the example shown, an intensity gap width ILB between the ring beam 10 and the core beam 9 is in this case about 43 μm, calculated from (160 μm-75 μm)/2, corresponding to (IRSD−KSD)/2. It should be noted that, in other embodiments, considerably smaller intensity gap widths ILB may also be selected, in particular so that ILB≤0.3*KSD.

An overall beam diameter GD of the overall laser beam, that is to say the superposition of the core beam 9 and the ring beam 10, determined according to the 86% criterion (so that 86% of the laser power of the overall laser beam lies within GD), is in this case about 340 μm. This comparatively large spot diameter is used in this case to weld the Al alloy of a cathode as a first component.

A Cu alloy of an anode as a second component is then intended to be welded on the same workpiece with the same overall laser power. For this purpose, the distribution of the laser energy is switched, for example by shifting the optical wedge as shown in FIG. 1a. FIG. 4b shows the intensity profile as is then applied in the second welding zone when welding the second component. For this purpose, a second core fraction KA2 of 60% and a second ring fraction RA2 of 40% are selected as a new energy split. Thus, a core beam 9 and a ring beam 10 are again superimposed in the intensity profile. During the switching, in this case 40% of the laser power was relocated from the ring fraction to the core fraction.

The core beam 9 causes a significantly higher central local intensity maximum, with a maximum intensity of about 4.5 a.u. The core beam diameter KSD of the core beam 9, determined according to the 86% criterion, is unchanged at approximately 75 μm. The ring beam 10 again has a plateau region on each side of the core beam maximum, but with a considerably lower maximum intensity of in this case about 0.5 a.u. The outer ring beam diameter ARSD of the ring beam 10, determined according to the 86% criterion, is unchanged at approximately 400 μm. At the location of ARSD, the intensity of the ring beam 10 has already fallen somewhat in relation to the maximum intensity of the plateau region. If the corresponding intensity is sought on the inner side of the ring beam 10, this entails the inner ring beam diameter IRSD that is likewise unchanged at about 160 μm.

The overall beam diameter GD of the overall laser beam, that is to say the superposition of the core beam 9 and the ring beam 10, determined according to the 86% criterion, is in this case, however, only about 220 μm. This is because more intensity is now imparted at small radii, in the region of the core beam 9, and less laser intensity is imparted at larger radii. The relatively small spot size is very suitable for welding the Cu alloy of the second component.

It should be noted that the overall power of the laser beam has not changed during the switching.

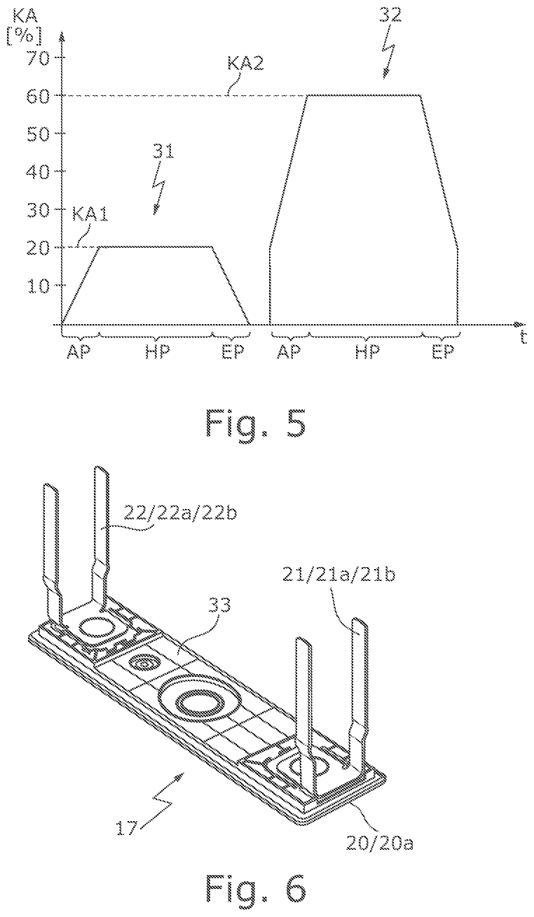

FIG. 5 illustrates a typical time profile of the energy distribution of a laser beam between the core fraction KA and the ring fraction RA over the welding of the first welding zone 31 and the second welding zone 32, as may also be used in the example of FIG. 4a and FIG. 4b. The time t is plotted on the right and the core fraction KA is plotted in % above; it should be noted that KA+RA=100%.

In the first welding zone 31, in an initial phase AP the core fraction KA is increased linearly with time t from 0% to 20%. In a main phase HP, the core fraction KA remains constant at 20%. In an end phase EP, the core fraction KA is reduced linearly with time from 20% to 0%. By the power ramps in the initial phase AP and the end phase EP, welding defects, in particular the splattering on entry and the pore formation on exit, may be reduced for the first component. It should be noted that the initial phase AP and the end phase EP are usually very much shorter than the main phase HP (typically with AP≤0.1*HP and EP≤0.1*EP). The welding of the first welding zone 31 is therefore characterized primarily by the main phase HP, and the core fraction KA in the main phase HP is referred to as a first core fraction KA1, in this case with KA1=20%. If the initial phase AP and the end phase EP are intended to have a larger fraction, KA1 may alternatively also be established as a time average of the core fraction KA over AP, HP and EP together (not represented in detail).

In the second welding zone 32, in an initial phase AP the core fraction KA is increased linearly with time t from 20% to 60%. In a main phase HP, the core fraction KA remains constant at 60%. In an end phase EP, the core fraction KA is reduced linearly with time from 60% to 20%. By the power ramps in the initial phase AP and the end phase EP, welding defects, in particular the splattering on entry and the pore formation on exit, may in turn be reduced for the second component. It should be noted that the initial phase AP and the end phase EP are usually very much shorter than the main phase HP (typically with AP≤0.1*HP and EP≤0.1*EP). The welding of the second welding zone 32 is therefore characterized primarily by the main phase HP, and the core fraction KA in the main phase HP is referred to as a second core fraction KA2, in this case with KA2=60%. If the initial phase AP and the end phase EP are intended to have a larger fraction, KA2 may alternatively also be established as a time average of the core fraction KA over AP, HP and EP together (not represented in detail).

In the example shown, KA1 and KA2 differ by 40%. It should be noted that a difference of at least 20% is preferred in some embodiments of the invention, and furthermore a difference of at least 30% is preferred. It should be noted that, in the diagrams of FIG. 4a, 4b above, the intensity distributions from the main phases HP have respectively been shown.

FIG. 6 shows a workpiece 17 that has been welded with the method according to embodiments of the invention. The workpiece 17 comprises a lid 20a of a prismatic cell of an electric battery as a base part 20, onto which a cathode 21a as a first component 21, which is configured as a fork-like soft connector 21b comprising an Al alloy, and an anode 22a as a second component 22, which is likewise configured as a fork-like soft connector 22b comprising a Cu alloy, have been welded with the method according to embodiments of the invention. In addition, a cover 33 has also been applied on the lid 20a here.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for laser welding of a workpiece, the method comprising:
directing a laser beam onto the workpiece by using scanner optics, and
in an arbitrary order with the laser beam, welding a first component to a base part of the workpiece at least in a first welding zone, and welding a second component to the base part in a second welding zone,
wherein the first component and the second component comprise different materials at least in the first welding zone and the second welding zone,
wherein
a laser energy of the laser beam is capable of being split variably at least between a core fraction, corresponding to a core beam of the laser beam, and a ring fraction, corresponding to a ring beam of the laser beam that encloses the core beam,
and wherein the splitting of the laser energy between the core fraction and the ring fraction is selected differently for welding in the first welding zone and for welding in the second welding zone.

2. The method as claimed in claim 1, wherein a position of the scanner optics relative to the workpiece remains same for welding in the first welding zone and for welding in the second welding zone.

3. The method as claimed in claim 1, wherein the core fractions of the laser energy during the welding in the first welding zone and during the welding in the second welding zone differ from each other by at least 20% as a time average.

4. The method as claimed in claim 1, wherein the core fraction KA1 of the laser energy as a time average and/or in a main phase during the welding in the first welding zone satisfies:
0%≤KA1≤60%,
and wherein the core fraction KA2 of the laser energy as a time average and/or in a main phase during the welding in the second welding zone satisfies:
40%≤KA2≤100%.

5. The method as claimed in claim 1, wherein the first component comprises aluminum or an aluminum alloy at least in the first welding zone, and the second component comprises copper or a copper alloy at least in the second welding zone.

6. The method as claimed in claim 1, wherein the workpiece is a lid for a prismatic cell of an electric battery,
and wherein the first component forms a cathode, and the second component forms an anode for the electric battery, wherein the first component and the second component are each configured as a fork-like soft connector for the prismatic cell.

7. The method as claimed in claim 1, wherein during the welding in the first welding zone and/or during the welding in the second welding zone, the core fraction of the laser energy is increased during an initial phase.

8. The method as claimed in claim 1, wherein during the welding in the first welding zone and/or during the welding in the second welding zone, the core fraction of the laser energy is decreased during an end phase.

9. The method as claimed in claim 1, wherein the laser beam is split into the core beam and the ring beam using a variable splitting device.

10. The method as claimed in claim 9, wherein, with the variable splitting device, the laser beam is fed, according to a desired splitting of the laser energy between the core fraction and the ring fraction, into a core fiber and into a ring fiber that encloses the core fiber.

11. The method as claimed in claim 10, wherein the variable splitting device comprises a displaceable optical wedge.

12. The method as claimed in claim 9, wherein, with the variable splitting device, the laser beam is guided, according to a desired splitting of the laser energy between the core portion and the ring portion, past a diffractive optical element (DOE) or a refractive optical element (ROE), and through the DOE or the ROE, wherein the DOE or the ROE is displaceable.

13. The method as claimed in claim 1, wherein the core beam is generated with a first laser module and the ring beam is generated with a second laser module, a power of the first laser module and a power of the second laser module being variably adjustable,
wherein the first laser module feeds a first precursor laser beam into a core fiber, and the second laser module feeds a second precursor laser beam into a ring fiber that encloses the core fiber.

14. The method as claimed in claim 1, wherein a diameter of the core beam KSD′ and a diameter of the ring beam ARSD′, measured on a workpiece surface facing toward the laser beam, satisfy:
1/10≤KSD′/ARSD′≤1/2.

15. The method as claimed in claim 1, wherein a diameter of the core beam KSD′ and a diameter of the ring beam ARSD′, measured on a workpiece surface facing toward the laser beam, remain constant during the welding in the first welding zone and the welding in the second welding zone.

16. The method as claimed in claim 1, wherein the scanner optics is configured as 3D scanner optics, and wherein a diameter of the core beam KSD′ and a diameter of the ring beam ARSD′, measured on a workpiece surface facing toward the laser beam, are varied by using the 3D scanner optics during the welding in the first welding zone and the welding in the second welding zone by changing a focal position in a propagation direction of the laser beam.

17. The method as claimed in claim 1,
wherein, in a focal plane,
the core beam has a core beam diameter KSD inside which there is 86% of a laser power of the core beam,
the ring beam has an outer ring beam diameter ARSD inside which there is 86% of a laser power of the ring beam,
the ring beam has an inner ring beam diameter IRSD on which there is an equal radiation density of the ring beam, averaged over a circumference, as on the outer ring beam diameter ARSD, so that there is an intensity gap between the inner ring beam diameter IRSD and the core beam diameter KSD, with an intensity gap width ILB=(IRSD−KSD)/2,
wherein ILB≤0.3*KSD and ILB<10 μm*AV, with AV being an imaging ratio of the scanner optics,
wherein the laser beam is provided at a fiber end of a fiber-optic cable, and the fiber-optic cable is formed at least with a core fiber having a core fiber diameter KFD, a ring fiber annularly enclosing the core fiber and having an outer ring fiber diameter ARFD, and a cladding layer lying between the core fiber and the ring fiber, enclosing the core fiber and having a cladding layer thickness MSD, with MSD≤0.3*KFD and MSD<10 μm.

18. The method as claimed in claim 1, wherein the welding in the first welding zone and the welding in the second welding zone is performed in such a way that
for a welding depth ET, 100 μm≤ ET≤5 mm applies, and/or
for an aspect ratio T:B of a depth T to a width B of a generated weld seam: T:B≥0.5:1 applies, and/or
for a beam parameter product SPP of the laser beam in a single mode, 0.38 mm*mrad≤ SSP≤16 mm*mrad applies, or in a multimode, SSP≤100 mm*mrad applies, and/or for an overall beam diameter GD′ of the laser beam on a workpiece surface facing toward the laser beam in the single mode, 10 μm≤ GD′≤300 μm applies, or in the multimode 50 μm≤ GD′≤1200 μm applies, and/or
the laser beam is generated with at least one IR laser with an average wavelength MWL, with 800 nm≤ MWL≤1200 nm, or at least one VIS laser, with an average wavelength MWL, with 400 nm≤ MWL≤450 nm or 500 nm≤ MWL≤530 nm, and/or
the scanner optics has an imaging ratio AV, with 1:1≤ AV≤5:1.

19. A prismatic cell for an electric battery, the prismatic cell comprising a lid and two fork-like soft connectors, wherein the two soft connectors as the first component and the second component are welded to the lid as the base part with a method as claimed in claim 1.
